(19) United States
(12) Patent Application Publication
(10) Pub. No.: US 2006/0033474 A1
(43) Pub. Date: Feb. 16, 2006

(54) USB battery charger

(76) Inventor: Kin Edward Shum, Palo Alto, CA (US)

Correspondence Address: ADVANCED ANALOGIC TECHNOLOGIES, 830 EAST ARQUES AVE, SUNNYVALE, CA, 94085, US

(21) Appl. No.: 10/916,339

(22) Filed: Aug. 11, 2004

(51) Int. Cl. H02J 7/00

(52) U.S. Cl. 320/128

(57) ABSTRACT

A USB battery includes a transistor that controls the flow of current between a USB host and a battery. The transistor is controlled a function of: 1) the amount of current flowing to the battery, and 2) the voltage on the USB V_{BUS} circuit. The transistor dynamically regulates the amount of trickle current to approach a predetermined maximum as closely as practical while maintaining the voltage on the VBUS circuit above a predetermined minimum.

### TECHNICAL FIELD OF THE INVENTION

The present invention relates generally to portable electronic devices. More particularly, the present invention relates to devices for charging batteries using power supplied by a universal serial bus.

### BACKGROUND OF THE INVENTION

In recent years, the universal serial bus (USB) has become one of the most widely used methods for interconnecting electronic devices. Originally used to interconnect computers and standard peripheral devices (such as disk drives), deployment of USB has grown to support a vast array of devices including cellular telephones, cameras and personal music players.

Logically, USB systems have an inverted tree-like structure. At top of the tree (i.e., at the root since the tree is inverted) is the USB host. Up to seven USB devices may be connected directly to the USB host. In cases where more than seven devices are required, a USB hub may be used. Each USB hub may be further connected to its own set of seven USB devices (or hubs as necessary). The USB connections between the USB host, USB hubs and USB devices allow data to flow between the USB host and USB devices. USB devices are also allowed to draw power from their USB connections. To this end, the USB standard (available from www.usb.org) requires that each USB host and USB hub provide power for its connected USB devices. Large USB devices, such as disk drives and printers, typically include their own power supplies and do not draw power from their USB connections. Smaller devices, on the other hand may be partially or fully powered from their connections. Devices that are fully powered by their USB connections are known as bus powered devices.

Battery powered USB devices are becoming increasingly popular with cellular telephones, personal digital assistants (PDAs), cameras and personal music players being, perhaps the most common examples. Adding a USB ports to these devices make it easy to upload and download information including names, phone numbers, calendars, photographs and music. It is also possible to use the USB port to charge the batteries in USB connected devices. This can be an extraordinarily convenient feature allowing cellphone users to charge their phones at work, for example, without the use of specialized wall adapters. Not surprisingly, the USB battery charger concept has even been used to build portable battery chargers that are used to recharge small general purpose batteries (e.g., AA and AAA). Among USB devices, chargers of this type are somewhat anomalous since they use the USB connection for power and not for data transfer.

USB devices that include battery chargers typically include some apparatus for regulating the amount of current used for charging. Regulation is required to prevent the charging process from drawing excessive current and starving the remainder of the USB device. Typically, this is accomplished by monitoring the current that goes to the charger and the current that goes to the device using two current sense resistors. While effective, this method has certain drawbacks. Among these is the fact that the resistors must be carefully selected to meet specific tolerances; otherwise they fail to accurately measure their respective currents. Another drawback is the fact that current sense resistors are relatively large and occupy significant real estate. This can be problematic, especially in the case of hand held or other portable devices. Still another drawback arises when a USB host or hub is actually capable of supplying more than the 500 ma required by the USB specifications. In such cases, the traditional regulating technique will operate as though the extra capability did not exist, and the charging process will be unnecessarily slowed.

### SUMMARY OF THE INVENTION

The present invention includes a USB battery charger. The battery charger is typically deployed within a USB device and is positioned to control the flow of current between the USB host and a battery that is also included in the USB device. Depending on the state of the battery, the charger operates in one of three modes: trickle charging, fast charging and voltage regulation. During trickle charging, the charger sends a preset trickle charge current to the battery as long as the battery voltage is below a normal level. Once the battery reaches the normal level, fast charging is initiated with a preset high charge current (assuming, again that the voltage of the USB V_{BUS} circuit can be maintained). In fast charge mode, the charge current is regulated as long as the USB bus voltage (V_{BUS}) can support it. When the USB becomes incapable of supplying the preset charge current, V_{BUS} drops. At that point, a “charge reduction loop” within the battery charger reduces the charge current to maintain V_{BUS}. In this way, the charge current is maximized to the extent possible without reducing V_{BUS}. The V_{BUS} triggering point can be set by the user with a resistor divider.

### BRIEF DESCRIPTION OF THE DRAWINGS

FIG. 1 is a block diagram of a USB battery charger deployed as part of a USB device.

FIG. 2 is a block diagram of a USB battery charger as provided by an embodiment of the present invention.

### DETAILED DESCRIPTION OF THE PREFERRED EMBODIMENTS

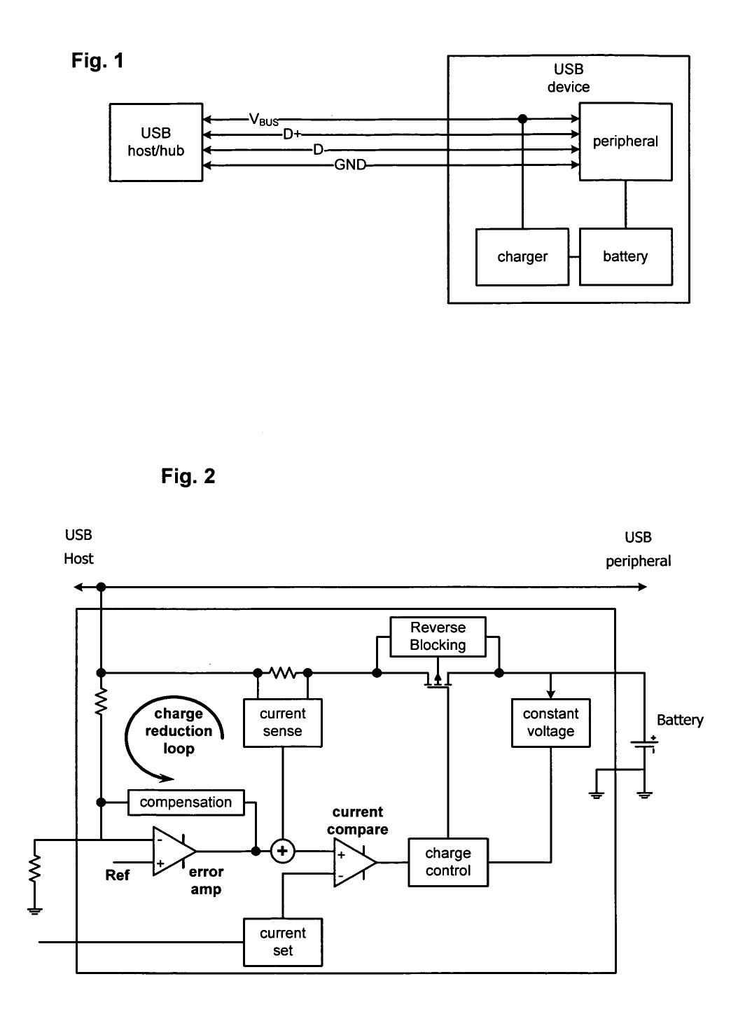

The present invention includes a charger for batteries in USB devices. As shown in FIG. 1, the charger is typically included, along with a battery, as part of a USB device. In most cases (but not in all cases) the USB device would also include some other functional block such as a cellular telephone or personal music player. In FIG. 1, this functional block is generically labeled “USB peripheral.” The charger is powered by a USB host via the USB V_{BUS} circuit. The V_{BUS} circuit is also typically used to power the USB peripheral. The charger uses power from the USB V_{BUS} circuit to charge the battery enabling operation of the USB device when disconnected from the USB host (or hub).

One possible implementation for the USB charger is shown in FIG. 2. As shown in that figure, the charger includes a path for current to flow from the USB V_{BUS} circuit to the battery. The path includes a current sense resistor and a transistor. In this case, the transistor is a MOSFET, but there are implementations where other transistor types may be used. The transistor is controlled to regulate the amount of current flowing to the battery and the voltage over the current sense resistor indicates the magnitude of the flowing current.

An error amplifier monitors the voltage on the USB V_{BUS} circuit. In this case, the error amplifier is positioned between two resistors, meaning that the voltage supplied to the error amplifier is actually proportional to the V_{BUS} voltage. The second input to the error amplifier is a reference voltage. The output of the error amplifier indicates the degree to which the V_{BUS} voltage differs from a predetermined minimum value.

A current sense circuit measures the current flowing through the current sense resistor (i.e., the voltage drop over the current sense resistor). The output of the error amplifier is added, via a summing amplifier to the output of the current sense resistor when the V_{BUS} voltage falls below the predetermined minimum. In effect, the combined signal appears as if more current is flowing to the battery (than there actually is) whenever the V_{BUS} voltage drops to the predetermined minimum. So the error amplifier reduces the actual charge current just enough to keep V_{BUS} regulated at the predetermined minimum.

The V_{BUS} sensing (resistor divider), error amplifier and summing amplifier add a “charge reduction loop” to the control system. This loop is only activated during fast charging when V_{BUS} drops to the regulation level set by the resistor divider. As shown in FIG. 1, compensation circuitry is positioned in parallel with the error amplifier to ensure stable operation of the charge reduction loop.

The combined error amplifier and current sense signal forms one input to a differential amplifier labeled “current compare” in FIG. 2. The second input to the differential amplifier is provided by a current set circuit. The output of the current set circuit is controlled by an external input. The output of the differential amplifier corresponds to the difference between the desired current and the combined error amplifier and current sense signals.

The output of the differential amplifier passes through a charge control circuit and is used to drive the transistor. The charge control circuit is included to support alternate battery charging strategies (besides constant current). For a typical implementation, three different charging modes are supported: trickle charging, fast charging and voltage regulation. During trickle charging, the charger charges the battery at a lower current as long as the battery voltage is below a normal level. Once the battery reaches the normal level, fast charging is initiated with a preset high charge current (assuming that the voltage of the USB V_{BUS} circuit can be maintained).

When the battery voltage reaches end of charge (EOC) level, the battery charger operates in voltage regulation mode. In this mode, the amount of current sent to the battery varies depending on need as long as the V_{BUS} voltage remains at the predetermined level.

Compared to other approaches, the battery charger just described has several advantages. One is that it avoids the expense and space required by designs using multiple current sensing resistors. Another is the ability of this battery charger to dynamically regulate the charging process. The battery is charged at a rate that approaches the maximum rate as closely as practical while maintaining the voltage on the V_{BUS} circuit above the predetermined minimum. This is true even when the USB host can supply more or less current than is required by the USB specification.

What is claimed is:

1. A method for charging a battery in a device attached to a universal serial bus (USB), the method comprising:
diverting electrical current from the USB VBUS circuit to the battery where the amount of diverted current is dynamically regulated to approach a predetermined maximum as closely as practical while maintaining the voltage on the VBUS circuit above a predetermined minimum.

2. A method as recited in claim 1 where the predetermined maximum is selectable between two or more values.

3. A method as recited in claim 2 in which the two or more values include a 100 mA and 500 mA values.

4. A method as recited in claim 1 in which the diverted electrical current is regulated by a transistor and in which the transistor is controlled as a function of the voltage of the VBUS circuit, the amount of diverted current and the predetermined maximum.

5. A method as recited in claim 1 in which the battery is a 4.2 volt lithium ion battery.

6. An apparatus for charging a battery in a device attached to a universal serial bus (USB), the apparatus comprising:
a circuit for diverting electrical current from the USB VBUS circuit to the battery where the amount of diverted current is dynamically regulated to approach a predetermined maximum as closely as practical while maintaining the voltage on the VBUS circuit above a predetermined minimum.

7. An apparatus as recited in claim 6 where the predetermined maximum is selectable between two or more values.

8. An apparatus as recited in claim 7 in which the two or more values include a 100 mA and 500 mA values.

9. An apparatus as recited in claim 6 in which the diverted electrical current is regulated by a transistor and in which the transistor is controlled as a function of the voltage of the VBUS circuit, the amount of diverted current and the predetermined maximum.

10. An apparatus as recited in claim 6 in which the battery is a 4.2 volt lithium ion battery.

11. A method for charging a battery in a device attached to a universal serial bus (USB), the method comprising:
diverting electrical current from the USB VBUS circuit to the battery;
monitoring the amount of diverted current;
monitoring the voltage on the VBUS circuit; and
dynamically regulating the amount of diverted current to approach a predetermined maximum as closely as practical while maintaining the voltage on the VBUS circuit above a predetermined minimum.

12. A method as recited in claim 11 that further comprises the step of sensing the state of an input to set the predetermined maximum.

13. A method as recited in which the amount of diverted current is monitored using a sense resistor.

14. A method as recited in claim 11 in which the diverted electrical current is regulated by a transistor and in which the transistor is controlled as a function of the voltage of the VBUS circuit, the amount of diverted current and the predetermined maximum.

15. A method as recited in claim 11 in which the battery is a 4.2 volt lithium ion battery.

16. An apparatus for charging a battery in a device attached to a universal serial bus (USB), the apparatus comprising:
a transistor connected to control an electric current flowing from the USB VBUS circuit to the battery;
a sense resistor configured to monitor the amount of the electric current; and
a control circuit configured to drive the transistor so that the amount of electric current flowing to the battery equals a predetermined maximum reduced by an amount sufficient to maintain on the VBUS circuit above a predetermined minimum.

17. An apparatus as recited in claim 16 that further comprises an error amplifier configured to produce a voltage proportional to the difference between a reference voltage and the voltage on the VBUS circuit

18. An apparatus as recited in claim 16 where the predetermined maximum is selectable between two or more values.

19. An apparatus as recited in claim 18 in which the two or more values include a 100 mA and 500 mA values.

20. An apparatus as recited in claim 16 in which the battery is a 4.2 volt lithium ion battery.
